(19) United States
(12) Patent Application Publication
(10) Pub. No.: US 2009/0313094 A1
(43) Pub. Date: Dec. 17, 2009

(54) METHOD AND SYSTEM FOR INCREASING VOTER PARTICIPATION IN ELECTIONS

(76) Inventor: Ravneet Singh, Naperville, IL (US)

Correspondence Address: CARDINAL LAW GROUP, LLC, SUITE 2000, 1603 ORRINGTON AVENUE, EVANSTON, IL, 60201, US

(21) Appl. No.: 12/281,917

(22) PCT Filed: Mar. 7, 2007
(86) PCT No.: PCT/US07/63506

§ 371 Date: Feb. 2, 2009

Related U.S. Application Data
(60) Provisional application No. 60/780,247, filed on Mar. 7, 2006.

(51) Int. Cl. G06Q 50/00; G06F 17/00; G06Q 10/00; G06F 17/30

(52) U.S. Cl. 705/12; 705/30; 707/104.1; 707/E17.044

(57) ABSTRACT

A method of providing election information includes receiving voter profile information from a voter, associating a personal identifier with at least a portion of the voter profile information, determining at least one voting classification information based on at least a portion of the voter profile information and at least one public record database; and providing at least a portion of the determined voting classification information to the voter via a voter interface. A method for providing voter profile information to a candidate includes receiving a plurality of voter profiles at a voter space database, receiving at least one candidate profile at the voter space database from at least one candidate, determining at least one voter profile based on the candidate profile, and providing the voter profile to the candidate via a candidate interface.

### RELATED APPLICATIONS

This application claims the benefit of U.S. Provisional Patent Application No. 60/780,247 filed Mar. 7, 2006.

### FIELD OF THE INVENTION

The present invention relates to Internet-based non-partisan solutions for elections and campaigns. The present invention generally relates to access to and maintenance of various enrolled Internet services and purchased Internet tools for elections and campaigns through a single gateway.

### BACKGROUND OF THE INVENTION

ElectionMall™ Technologies, Inc (hereinafter “Election Mall”) is continually striving to be the world leader in providing Internet-based non-partisan solutions for elections and campaigns that effectively utilizes technology and business know-how to enable candidates, organizations and other elected representatives to generate enhanced gains in awareness, funds and votes. To this end, as illustrated in FIG. 1, the winning solutions provided by Election Mall encompass fundraising for soliciting and managing election and campaign finances, web services for managing elections and campaigns, tools for managing election and campaign content, Get-Out-The-Vote (“GOTV”) for sending election and campaign messages in an efficient manner, and shopping for providing access to election and campaign products (e.g., eyardsigns).

The website applications for providing the winning solutions currently offered by Election Mall are in different technologies, such as, for example, ASP, PHP and .NET as known in the art. Furthermore, various database servers are used the website applications. A challenge therefore for Election Mall was to enable its customers/members to have access to its winning solutions from one single gateway. Additionally, Election Mall is continually striving to improve upon and add to website applications for providing its winning solutions.

Participation in the electoral process has been hampered by difficulties in obtaining the knowledge to best exercise the democratic principles. For example, many voters may be confused about their polling place, where they are registered to vote, the views of candidates, or their ability to contribute money to candidates. Often, voters may fail to participate in an election due to a lack of even knowing where to go. Other times, the voter may rely on the “approval” lists published by various groups, such as newspapers, unions, or political action groups. In addition, voters may fail to support candidates that would match the views of the voter for lack of knowledge of the candidate's identity, or fail to support the candidate with as much money as the voter could.

From a candidate perspective, reaching voters that share similar ideology is beneficial, but an individual targeting effort is difficult. Furthermore, raising funds from voters who are unsure about their previous contributions or maximum permissible contributions is made difficult due to gaps in voter understanding or knowledge.

It would be desirable to advance the state of the art to solve these problems, as well as others, to advance participation in democratic elections.

### SUMMARY OF THE INVENTION

The present invention provides a new and unique universal membership to the website applications for providing winning solutions of Election Mall as well as providing several new and unique website applications.

One aspect of the invention provides a method of providing election information includes receiving voter profile information from a voter, associating a personal identifier with at least a portion of the voter profile information, determining at least one voting classification information based on at least a portion of the voter profile information and at least one public record database; and providing at least a portion of the determined voting classification information to the voter via a voter interface.

A second aspect of the invention provides a method for providing voter profile information to a candidate includes receiving a plurality of voter profiles at a voter space database, receiving at least one candidate profile at the voter space database from at least one candidate, determining at least one voter profile based on the candidate profile, and providing the voter profile to the candidate via a candidate interface.

Other aspects of the invention include a computer usable medium including computer readable code for implementing the methods steps.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 illustrates one embodiment of a universal membership architecture in accordance with the present invention.

FIG. 2 illustrates a first embodiment of a web server in accordance with the present invention;

FIG. 3 illustrates a second embodiment of a web server in accordance with the present invention;

FIG. 4 illustrates one embodiment of an election shopping website in accordance with the present invention;

FIG. 5 illustrates one embodiment of a method for providing election information, in accordance with the invention; and

FIG. 6 illustrates one embodiment of a method for providing election information in accordance with the invention.

### DETAILED DESCRIPTION OF THE INVENTION

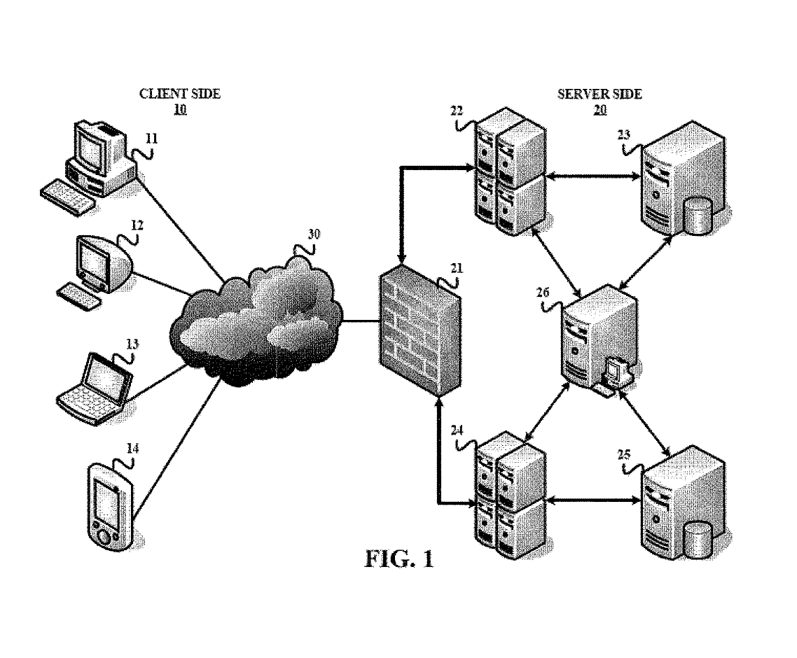

FIG. 1 illustrates an exemplary architecture of the present invention having a client side 10 and a server side 20 connected via a wide area network 30, such as, for example, the Internet. The client side 10 employs a personal computer client 11, a Macintosh client 12, a laptop client 13 and a personal data assistant client 14. The server side 20 employs a firewall 21, a Microsoft web server 22, a SQL database server 23, a Linux web server 24, a MySQL database server 25 and a SOAP listener server 26.

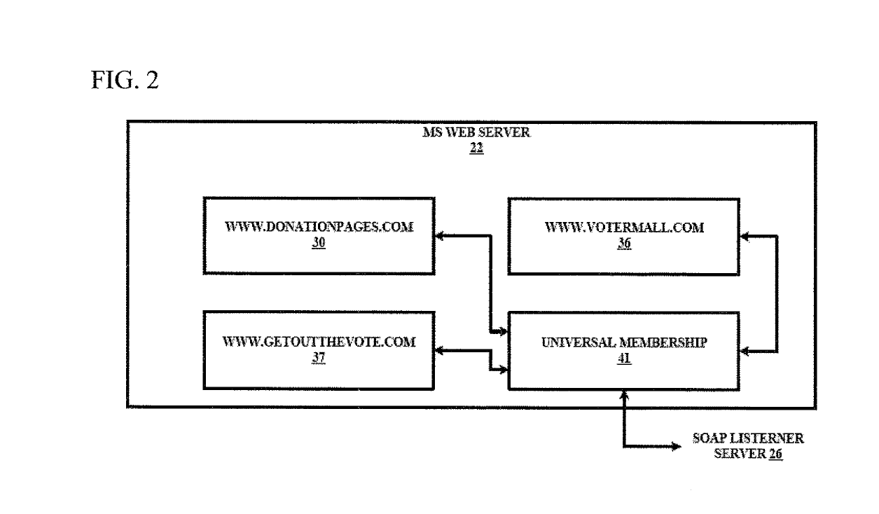

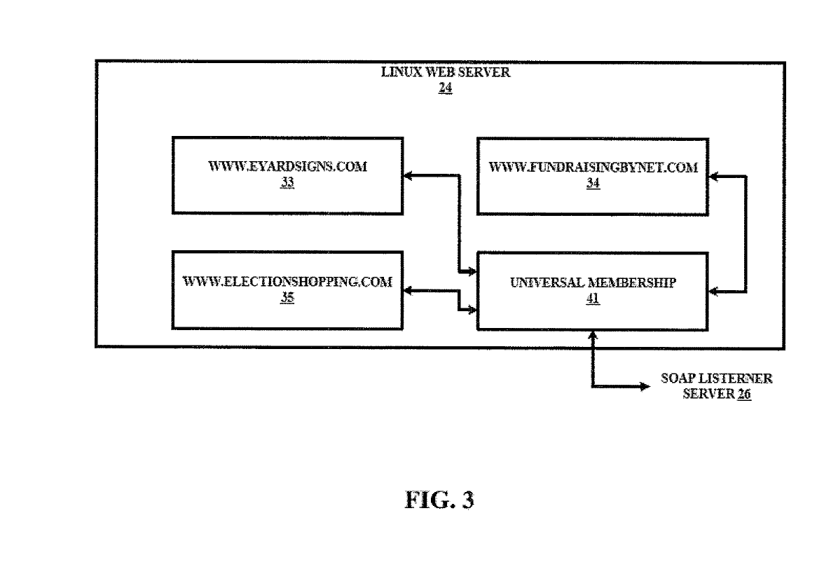

By design, non-partisan solutions for elections and campaigns developed by Election Mall are embodied in various website applications installed on Microsoft web server 22 and Linux web server 24. For example, as illustrated in FIG. 2, a www.donationspages.com website application 30, a www.votermall.com website application 31 and a www.getoutthevote.com website application 32 are installed on Microsoft web server 22. Similarly, as illustrated in FIG. 3, a www.eyardsigns.com website application 33, a www.fundraisingbynet.com website application 34 and a www.electionshopping.com website application 35 are installed on Linux web server 24.

The www.donationspages.com website application 30 (FIG. 2) is an online directory that enables campaign professionals to quickly search for the services and products they need in order to conduct successful campaigns and win elections. Visitors can search for listings by name, category, or party affiliation. The directory is integrated with Google™ search and Yahoo Get Local Maps, which allows the user to get driving directions to a particular organization. It also allows users to post events for candidates of their choice and receive electronic tickets for events, with an approval invite system to the campaigns. Furthermore, at least one web application, in one embodiment, is configured to allow others to raise money on behalf of the campaigns in an authorized and secure manner. This exchange allows them to participate via the web, collect information like RSVP, others that will be attending, add comments, suggest other events to support. By allowing this, campaigns that currently host events don't have access to universal login of other events, but in this case the exchange allows the voters to determine their support. By participating in any of our Take Action items they will be able to be rewarded via electionmallshopping, which again gives them access to that site to pick and choose what they can receive. In certain embodiments, the central location can reward voters for their participation, such as by providing points, money, goods, or other rewards.

The www.votermall.com website application 31 (FIG. 2) is a web application configured to provide a venue for purchasing election related services and products. This destination site allows the voter to have access to all forms of political participation. A universal site that gives them an interface to engage in all campaigns, search, participate, donate, volunteer, register to vote, communicate, invite, join, share opinions, fill in forms, offer rides to polls, and get rewarded for their participation. This site has universal access to state and county databases that allow them to find out in real time if they are a voter or not, and in certain embodiments, both where the voter is registered, as well as the existence of registrations in multiple locations, and including overseas voting participation by voters such as ex patriates, armed forces, or the like. In one embodiment, the central location also sends and displays legal information about the guidelines for any election, which is not limited to political, school election, corporate election and private elections. This way a “mall” for the voters to find, be invited and engage with any election anytime. The polling aspects of sending emails to verify multiple databases against Full Name, address, phone, and email will validate information with US Census data and Federal and State Election Databases.

The www.getoutthevote.com website application 32 (FIG. 2) is an online service that allows a user to send election and campaign messages in the most efficient manner via various mediums, such as, for example, direct mail, radio, television, print, distribution, offline and online advertising, telematic devices, facsimiles and emails. The web interface is a control center for the campaigns. In one embodiment, this centralization of communications can affect voter participation both directly and/or indirectly. The voters that participate are proven they want engagement. Traditionally, campaigns target everyone within their district. For example, directing Get Out the Vote messages to voters illustrating their desire to be engaged (i.e. via registration or prior communications) increases the targeting of the GOTV message and improves the ability of a campaign to target efforts to voters with a profile matching the candidate profile. Or example, the central location may operate similar to a match-making site. GOTV only sends information to those who want to receive it and those who are likely to participate. In one embodiment, a ranking system is applied to further refine communication efforts. In one embodiment, the central location further monitors the engagement of the voters and those of the campaigns.

The www.eyardsigns.com website application 34 (FIG. 3) in an online tool that provides an electronic version of the traditional campaign yard sign. eYardSigns are permission-based e-mail greetings that a campaign may send to constituents and/or voters. In one embodiment, the eYardSigns have links to encourage supporters to volunteer, donate to the campaign, or pass the greeting on to friends and family. eYardSigns enable campaign staff to track recipients and collect e-mail addresses to create a targeted list of supporters. The ability to track their participation and have voters invite others to participate. In one embodiment, the eYardSigns ask a recipient to engage others to participate, and in other embodiments, invite recipients to join from any aspect of the campaign.

The www.fundraisingbynet.com website application 34 (FIG. 3) is an online service that enables a user in the capacity of a candidate, a fundraiser or a donor to raise funds for a particular campaign. In one embodiment, the central location creates a secure information to collect funds and directly deposit the funds to the campaign or universally access those funds as credits to be utilized in other campaign mall products to engage with voters in the space. As the campaigns raise funds they are allowed to spend that money in the mall. In one embodiment, the fundraising efforts are compliant with Federal and state laws, or other regulations that have eligibility issues, disclaimers, and specific regulations on the amounts of each contribution a voter can give. In one embodiment, donation information is matched and, in certain embodiments, the campaign receives a notification of overlimit contributions and/or warns of potential misgivings. In one embodiment, the central location substantially simultaneously educates voters and/or constituents to give from multiple locations to multiple candidates. In one embodiment, the central location facilitates the ability for a voter to give one contribution to multiple candidates. The voter in this case becomes a donor and is recorded in, for example, a database of the candidate filing which is matched with the candidate profile. Since voters are constant and campaigns continually have new candidates. In one embodiment, a match will be utilized in other access points helping campaigns solicit funds directly from voters who wish to give, or are more likely to give, or match to a specific campaign.

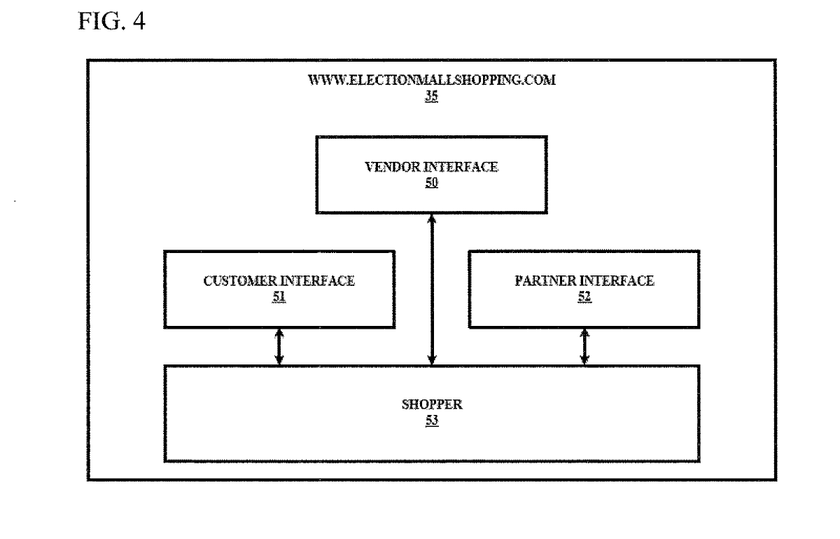

The www.electionshopping.com website application 35 is an online tool that provides a directory of campaign products. As illustrated in FIG. 4, a vendor interface 50 enables a vendor to submit information regarding the promotion and sale of its campaign products via a shopper 53. A customer interface 51 enables a customer to search for and purchase various campaign products supported by shopper 53. A partner interface 52 enables a sponsor of application 35 to be compensated for a customer performing any search and purchase of various campaign products supported by shopper 53 via interface 52. In one embodiment, voters are able to choose their rewards for engagement and/or campaigns can offer various rewards for voter engagement.

Referring back to FIG. 1, in operation, a user of Election Malls tools and services can directly visit any of the website applications whereby each website application may have links to one or more of the other website applications. Nonetheless, to facilitate a single gateway to all of the website applications, MS web server 22 further employs a universal membership 40 and Linux web server 41 further employs a universal membership 41 that are structurally configured to communicate with SOAP listener server 26 via an XML format. Specifically, a user can register for a universal membership login on any of the website applications that enables the user to be simultaneously linked to all of the website applications that user is registered for.

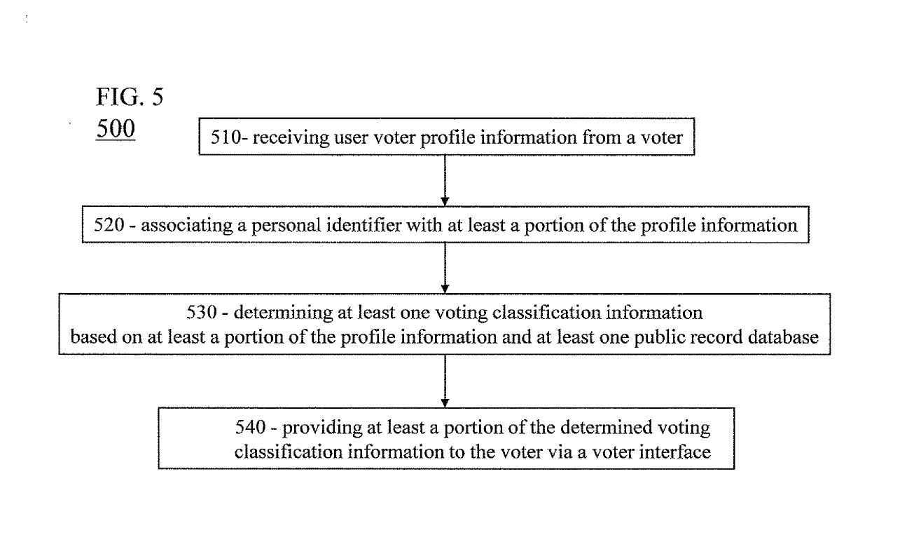

FIG. 5 illustrates one embodiment of a method 500 for providing election information in accordance with one aspect of the invention. Method 500 begins by receiving voter profile information from a voter at step 510. The voter profile information can be any information associated with a voter, such as name, address, geographic residential information, email, spousal information, issues, voting history, geographic business information, phone numbers, political affiliation, political view information, precinct information, financial donations, religious affiliation, union affiliations, political action group affiliations, and the like. The voter profile information is received at a central location, such as web server 22, or any of the web applications described above.

Method 500 then associates a personal identifier with at least a portion of the voter profile information at step 520. The personal identifier can be selected by the voter, or by the central location. In one embodiment, password protection is used to increase the level of security.

At least one voting classification information is determined at step 530 based on at least a portion of the voter profile information and at least one public record database. The voter profile information is compared to public record databases to determine voting classification information. The voting classification information can include any information to increase participation in the electoral process, such as precinct and polling place information, candidate lists, candidate views on political issues, campaign financial information, previous financial donations to candidates for the instant election, the difference between previous financial donations and a maximum allowable financial donation, polling numbers, contact information for candidates, suggested voting based on voter political views as compared to candidate political views, candidate endorsement information. The public databases can be any databases controlled by a political subdivision, or any database open to public review. For example, the central location can search databases maintained by the Federal Election Commission, local election boards, or the like.

In one embodiment, the voting classification information is based on private candidate database information, in addition to the public databases. For example, each candidate may maintain a private database, such as behind a firewall or other such security device, and provide access to the private database to the central location. For example, the candidate may make political viewpoint information available. Alternatively, the candidate may make previous donations made by the voter available so that the voter may make additional donations if the previous donations are less than the voter would like to make or are less than any possible maximum allowable donations.

Method 500 continues at step 540 by providing at least a portion of the determined voting classification information to the voter via a voter interface. The voter interface can be paper based, such as a printout generated by a computer via a printing device, via a wireless connection, email, or via a web interface.

Method 500, and its variations, can be used to provide, for example, a customized voting list responsive to voter political views and candidate political views. The political views of both candidates and voters can be bright line views (i.e. for or against), or can be based on a sliding scale (such as 1-10, 1-100, or non-numeric scales). The methods can also be used to provide a voter with a list of elections for which the voter is eligible to vote in, a list of candidates vying for the contested offices, their views and/or bios, or the like.

For example, a voter in Chicago, IL registers at the central location, and determines that they reside in a particular precinct, that their polling place is located at a particular place, the polling place is open between certain hours, and receives a list of offices subject to the election, including the candidates competing for each office. The voter can receive a customized voting list, describing which candidates are closest to the voter's political views. The voter can receive a list describing how much money the voter has already donated to election campaigns, and if campaign contribution limits are enforced, how much more, if any, money the voter can donate to candidates.

In one embodiment, the voter can register to vote from the central location. In another embodiment, the central location provides a venue and/or support for the distribution of audiovisual files between and among voters and campaigns, and for users (such as voters and campaigns) to provide comments and ratings for each file as well as to suggest that other voters and/or campaigns may benefit from reviewing the contents of the file.

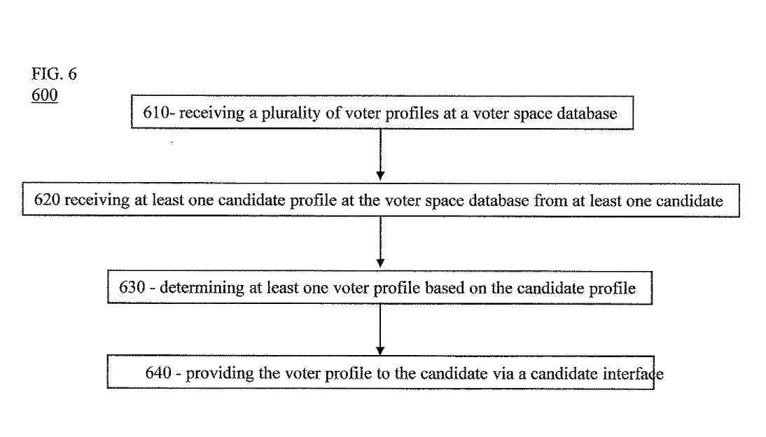

FIG. 6 illustrates one embodiment of a method 600 for providing voter profile information to a candidate, in accordance with one aspect of the invention. Method 600 begins at step 610 by receiving a plurality of voter profiles at a voter space database. The voter space database is a central location, such as the web server 22 described above. The voter profiles are data associated with voters, such as their address, political affiliations, etc.

At least one candidate profile is received at the voter space database at step 620. The candidate profile is information associated with a candidate for a political office, such as name, campaign contact information such as offices, phone numbers, web addresses and the like. The candidate profile, in certain embodiments, further contains such information as the position for which the candidate is running, political affiliations, religious affiliations, union affiliations, political view information, and the like.

At least one voter profile is determined at step 630 based on the candidate profile. The voter profile includes information associated with voters who are possible supporters of the candidate, based on such profile data as geography, political affiliations, union affiliations, demographic characteristics, and the like. In another embodiment, the determination of voter profiles is responsive to campaign donation information.

Method 600 then provides the determined voter profiles to the candidate via a candidate interface. The candidate interface can be paper based, such as a printout generated by a computer via a printing device, via a wireless connection, email, or via a web interface. The candidate interface can be the same or different than the voter interface.

In one embodiment, method 600 further includes determining at least one financial contribution record associated with the determined voter profile, such as by accessing election databases, and comparing the determined financial contribution record with a threshold financial contribution. In one embodiment, the method further includes providing at least one of the determined financial contribution and a difference between the determined financial contribution record and threshold financial contribution to the candidate based on the comparison. In certain jurisdictions, legal limits for maximum financial contributions by a person have been established, and knowledge of prior voter contributions inures to the benefits of both the voter desiring to contribute financially to a campaign, as well as the candidate desiring to receive additional contributions.

In one embodiment, the central location further provides for additional functionality, such as social networking among and between voters of particular profiles. In such social networking embodiments, each voter has a page and can link to other voters based on profile characteristics, such as geography, political affiliation, age, gender, and the like. In other embodiments, the central location provides blogging capability to enable voters to maintain a blog or other online diary.

In one embodiment, the central location includes capability for voters to send e-cards touting a variety of messages, such as political, well wishing, happy birthday, and the like.

In one embodiment, the central location provides for the generation and award of a variety of rewards or points awardable to voters for various conduct and supplied or paid for by a campaign. For example, a voter may receive a predetermined number of points for hosting a eYardSign, and these points are redeemable for objects of value, such as money, campaign swag, or the like. In other examples, points can be awarded for signing up voters, hosting fundraisers, organizing donations, GOTV efforts, efforts supporting candidates, or the like. In one embodiment, rewards are not awardable for actual voting. In one embodiment, the award of rewards, as well as the expenses associated with awarded rewards, is tracked by the central location. In certain embodiments, invoices to the campaigns can be generated, and fulfillment of the awarded rewards can be governed by the central location.

The disclosures herein provide for a gateway for both voters and candidates to secure information needed to better decide on which candidate to vote for, as well as better access supporters. This election mall provides a simple place in voter space for voters to access candidate information and decide on voting and financial contributions. Similarly, this election mall provides a simple place for candidates to better reach and identify supporters for solicitation of votes, as well as action and financial support from voters.

Thus, the disclosures herein provide for campaigns engaging in certain activities, while voters participate in these activities. Technology, and the disclosures herein, help to facilitate voters participation in the campaign activities to increase voter engagement. These disclosures improve voter access to campaigns, and improve campaign access to voters. Since campaigns are more likely to attract voters who participate by engaging the voters, such as via the disclosures herein, the democratic process is helped by participation with a universal access login. This universal access login facilitates engagement from both voters and candidates. The technology software can gather and identify voter profiles of behavior to improve campaign access to voters, while also gathering and identifying profiles of candidates to improve voter access to campaigns so that both sides of the democratic process gain. Voter classifications can improve campaign outreach, such as by classifying the most engaged voters into desirable categories, and using analytics to match voters and campaigns. Use of a central access point helps both voters and campaigns so that neither party must go to an extended number of sites to find information, visit multiple candidates, attend or reserve space at fundraising events, participate in one or many campaigns, obtain polling information, become registered volunteers, and/or determine relevant dates (voting day, primary information, financial donation cut-offs or the like). Some voters may receive additional incentive for engaging in the democratic process by receiving various rewards for their engagement. In addition, engaged voters can receive a voting guide tailored to their interests, while the campaign receives a space to engage constituents and increase e-participation in the democracy.

While the embodiments of the invention disclosed herein are presently considered to be preferred, various changes and modifications can be made without departing from the scope of the invention. The scope of the invention is indicated in the appended claims and all changes that come within the meaning and range of equivalents are intended to be embraced therein.

What is claimed is:

1. A method of providing election information, the method comprising:
receiving voter profile information from a voter;
associating a personal identifier with at least a portion of the voter profile information;
determining at least one voting classification information based on at least a portion of the voter profile information and at least one public record database; and
providing at least a portion of the determined voting classification information to the voter via a voter interface.

2. The method of claim 1 wherein the determining at least one voting classification information is further based on private candidate databases.

3. The method of claim 1 further comprising:
determining at least one candidate profile based on the determined voting classification information.

4. The method of claim 3 further comprising providing the candidate profile to the voter based on the user voter profile information and candidate profile.

5. The method of claim 1 wherein the voting classification information comprises at least one polling place location.

6. The method of claim 1 wherein the voting classification information comprises at least one financial contribution record.

7. The method of claim 1 wherein the voting classification information comprises at least one candidate profile.

8. The method of claim 7 further comprising receiving at least one voter political view from the voter and receiving at least one candidate political view from a candidate; comparing the at least one voter political view and at least one candidate political view, and wherein the candidate profile is provided based on the comparison.

9. A computer usable medium comprising computer readable code for providing election information, the medium comprising:
computer readable code for receiving user voter profile information from a voter;
computer readable code for associating a personal identifier with at least a portion of the profile information;
computer readable code for determining at least one voting classification information based on at least a portion of the profile information and at least one public record database; and
computer readable code for providing at least a portion of the determined classification information to the voter via a voter interface.

10. The medium of claim 9 further comprising:
computer readable code for determining at least one candidate profile based on the determined voting classification information.

11. The medium of claim 10 further comprising computer readable code for providing the candidate profile to the voter based on the user voter profile information and candidate profile.

12. The medium of claim 1 wherein the voting classification information comprises at least one of at least one polling place location, at least one financial contribution record and at least one candidate profile.

13. The medium of claim 12 further comprising computer readable code for receiving at least one political view from the voter and computer readable code for receiving at least one political view from a candidate; computer readable code for comparing the at least one political view from the voter and at least one political view from the candidate, and wherein the candidate profile is provided based on the comparison.

14. A method for providing voter profile information to a candidate, the method comprising:
receiving a plurality of voter profiles at a voter space database;
receiving at least one candidate profile at the voter space database from at least one candidate;
determining at least one voter profile based on the candidate profile; and
providing the voter profile to the candidate via a candidate interface.

15. The method of claim 14 further comprising:
determining at least one financial contribution record associated with the determined voter profile;
comparing the determined financial contribution record with a threshold financial contribution; and
providing at least one of the determined financial contribution and a difference between the determined financial contribution record and threshold financial contribution to the candidate based on the comparison.

16. The method of claim 14 further comprising receiving at least one political view from the voter and receiving at least one political view from a candidate; comparing the at least one political view from the voter and at least one political view from the candidate, and wherein the candidate profile is provided based on the comparison.
